(19) United States
(12) Patent Application Publication
(10) Pub. No.: US 2016/0379249 A1
(43) Pub. Date: Dec. 29, 2016

(54) PRIORITIZED ADVERTISING

(71) Applicant: International Business Machines Corporation, Armonk, NY (US)

(72) Inventors: Yuk L. Chan, Rochester, NY (US); Lawrence A. Clevenger, LaGrangeville, NY (US); Deepti M. Naphade, Cupertino, CA (US)

(21) Appl. No.: 14/747,564

(22) Filed: Jun. 23, 2015

(51) Int. Cl. G06Q 30/02

(52) U.S. Cl. CPC G06Q 30/0255

(57) ABSTRACT

A system, method, and program product that prioritizes Internet advertising for a particular product for a consumer. A system is disclosed that includes: an information gathering system that gathers purchasing information of a consumer; an identification analyzer that identifies at least one potential product for the consumer; a product analyzer that determines whether the at least one potential product is a utility item or a vanity item; and a prioritizing engine including: a vanity scoring engine that assigns an advertising score based on whether the consumer owns the vanity item, whether the vanity item is consumable, and a vanity score for the consumer and a utility scoring engine that assigns an advertising score based on whether the consumer owns the utility item and whether the utility item is consumable, wherein in response to the assigned advertising score exceeding an advertising threshold, an Internet advertisement is presented to the consumer.

### TECHNICAL FIELD

The subject matter of this invention relates to prioritizing advertising for a particular product for a consumer, and more particularly to assigning an advertising score to at least one potential product based on a set of criteria.

### BACKGROUND

Traditionally, targeted marketing has been applied to print marketing, wherein an advertiser decided which periodicals and publications were likely to be read by their target audience. With the growth of radio and television, these decisions extended to deciding between stations and programs. However, as the use of the Internet grew, along with email clients and social networking, a new type of targeted advertising developed. Predictive marketing techniques developed using these sources. In some cases, predictive marketing is currently utilized for determining products that a consumer may be interested in. These techniques frequently track life events and buying patterns, often with an eye towards brand affinities. The results of these techniques are commonly advertisements for products that a consumer no longer needs.

While it is relatively straightforward to identify potential products a consumer may be in the market for, it is difficult to prioritize these products in a simple “need based” analysis without presenting advertisements for already owned items. By virtue of the growth and reliance upon Internet based results, by the time the advertisement is presented to a consumer, the consumer has already purchased the item or a similar item.

One existing approach is to prioritize simply based on life events. Unfortunately, such approaches are often retrospective in nature, and result in inundating a consumer with advertisements for a product that has already been purchased.

### SUMMARY

The present disclosure describes a targeted marketing system and method that prioritizes advertising for a particular product for a consumer and avoids presenting advertising for an already purchased product.

A first aspect provides a targeted marketing system that prioritizes advertising for a particular product for a consumer, comprising: an information gathering system that gathers purchasing information of a consumer; an identification analyzer that identifies at least one potential product for the consumer; a product analyzer that determines whether the at least one potential product is a utility item or a vanity item; and a prioritizing engine comprising: a vanity scoring engine that, in response to the at least one potential product being a vanity item, assigns an advertising score based on whether the consumer owns the vanity item, whether the vanity item is consumable, and a vanity score for the consumer; and a utility scoring engine that, in response to the at least one potential product being a utility item, assigns an advertising score based on whether the consumer owns the utility item and whether the utility item is consumable.

A second aspect provides a computer program product stored on a computer readable storage medium, which when executed by a computing system, prioritizes advertising for a particular product for a consumer, comprising: program code that gathers purchasing information of a consumer; program code that identifies at least one potential product for the consumer; program code that determines whether the at least one potential product is a utility item or a vanity item; and program code that prioritizes, comprising: in response to determining that the at least one potential product is a vanity item, assigning an advertising score based on whether the consumer owns the vanity item, whether the vanity item is consumable, and a vanity score for the consumer; and in response to determining that the at least one potential product is a utility item, assigning an advertising score based on whether the consumer owns the utility item whether the utility item is consumable.

A third aspect provides a method for prioritizing advertising for a particular product for a consumer, comprising: gathering purchasing information of a consumer; identifying at least one potential product for the consumer; determining whether the at least one potential product is a utility item or a vanity item; and prioritizing, comprising: in response to determining that the at least one potential product is a vanity item, assigning an advertising score based on whether the consumer owns the vanity item, whether the vanity item is consumable, and a vanity score for the consumer; and in response to determining that the at least one potential product is a utility item, assigning an advertising score based on whether the consumer owns the utility item and whether the utility item is consumable.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having a targeted marketing system according to embodiments.

FIG. 2 shows a process flow for implementing the targeted marketing system according to embodiments.

FIG. 3 shows a process flow for implementing the targeted marketing system according to further embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

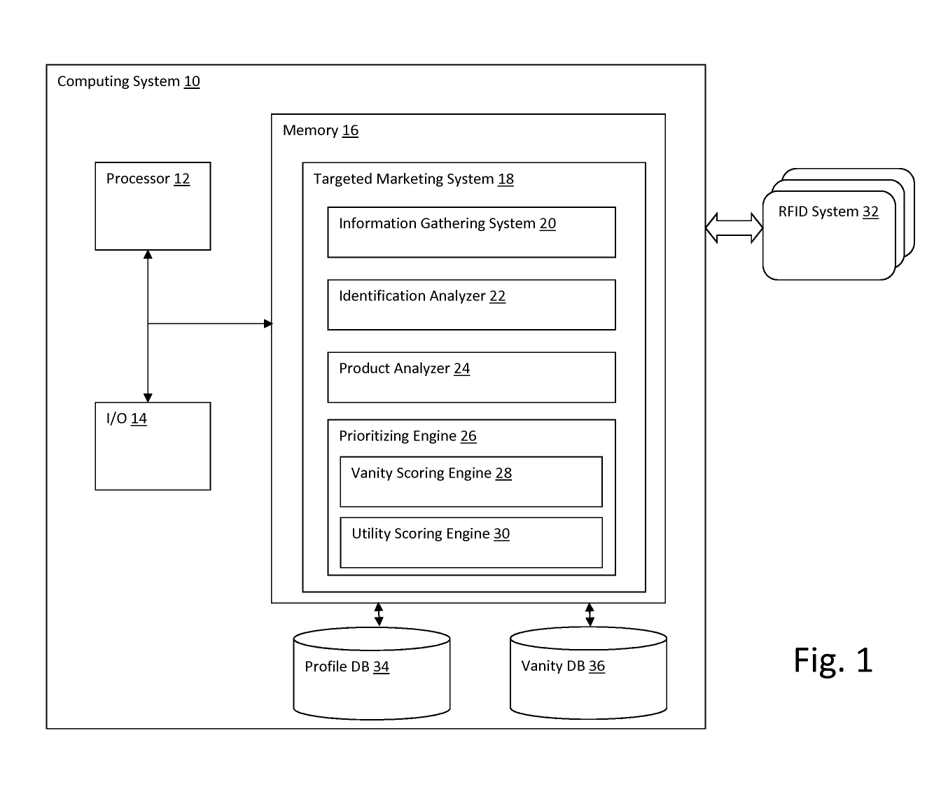

Referring now to the drawings, FIG. 1 depicts a computing system 10 including a targeted marketing system 18 for prioritizing advertising for a particular product or set of products for a consumer. For the purposes of this disclosure, the term product refers to any item(s) or service(s) which a consumer can purchase, lease, trade for, or any other form of commerce by which a consumer may acquire such goods or services. The term consumer can include any individual, organization, business, or entity capable of acquiring, purchasing, or otherwise consuming goods or services. Accordingly, computing system 10 may comprise a distributed computing infrastructure that facilitates advertising based on data about a consumer, or any other capable computing infrastructure.

FIG. 1 depicts an illustrative computing system 10 that may comprise any type of computing device and, and for example includes at least one processor 12, memory 16, an input/output (I/O) 14 (e.g., one or more I/O interfaces and/or devices), and a communications pathway. In general, processor(s) 12 execute program code which is at least partially fixed in memory 16. While executing program code, processor(s) 12 can process data, which can result in reading and/or writing transformed data from/to memory and/or I/O 14 for further processing. The pathway provides a communications link between each of the components in computing system 10. I/O 14 can comprise one or more human I/O devices, which enable a user to interact with computing system 10.

Furthermore, it is understood that targeted marketing system 18 or relevant components thereof (such as an API component) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will, select the proxy server code, determine on which computers to place the proxy servers' code, transmit the proxy server code, then install the proxy server code on the proxy computer. The components will be transmitted to the proxy server and then it will be stored on the proxy server.

Generally, targeted marketing system 18 includes: an information gathering system 20 that gathers purchasing information of a consumer; an identification analyzer 22 that identifies at least one potential product for the consumer; a product analyzer 24 that determines whether the at least one potential product is a utility item or a vanity item; and a prioritizing engine 26. Prioritizing engine 26 comprises a vanity scoring engine 28 and a utility scoring engine 30. Targeted marketing system may be in communication with a radio-frequency identification (RFID) system 32, which may include any number of RFID readers capable of determining what objects a consumer has with them or are currently using, and storage networks for storing data acquired by RFID readers. RFID system 32 may be included in targeted marketing system 18 or stored externally. When stored externally, any now known or later means of communication may be used to share information with RFID system 32. Targeted marketing system 18 may also be in communication with any number of databases, which may be internally or externally stored and in communication with targeted marketing system 18, including but not limited to the profile database (DB) 34 and vanity DB 36, which will be described with more detail below.

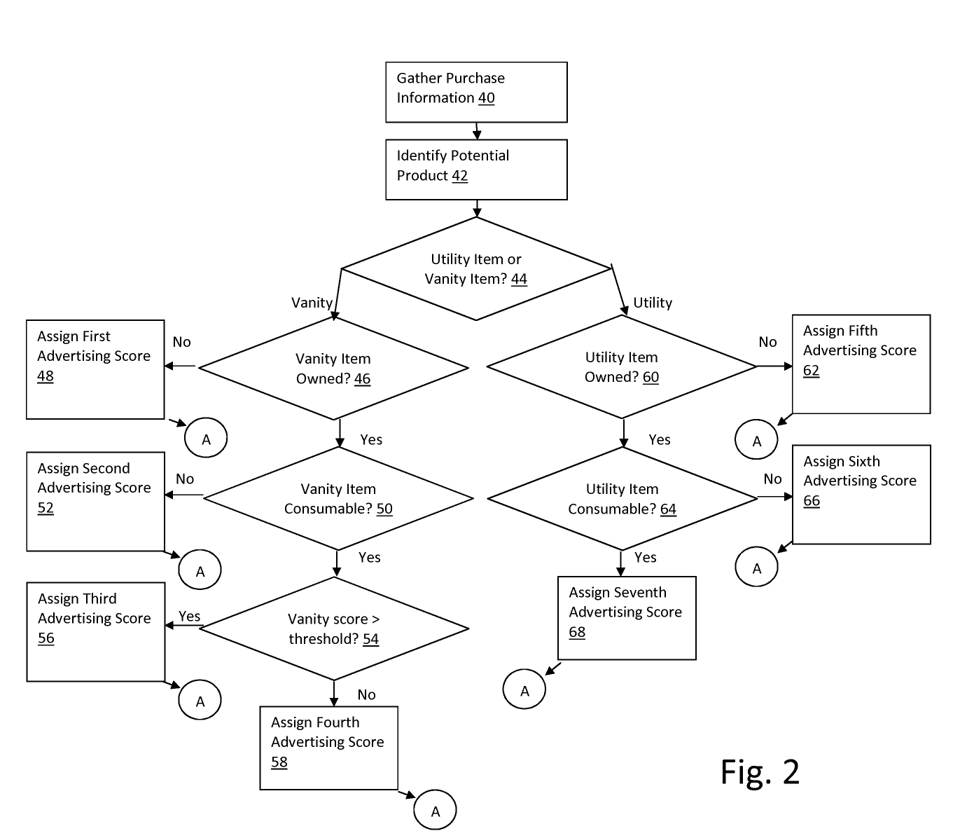

FIG. 2 depicts a flow diagram showing an illustrative process for implementing targeted marketing system 18. In embodiments, information gathering system 20 (FIG. 1) gathers purchasing information of a consumer at 40. For instance, information gathering system 20 may gather information about a consumer from profile database (DB) 34 (FIG. 1), which may be part of targeted marketing system 18 or may be externally located. Such information may be gathered from multiple sources, including but not limited to the Internet, a browser history of the user, one or more social networking profiles or histories, and one or more email clients. Any of these sources may gather and share information with profile DB 34 about the consumer and their browsing histories, views, clicks, likes, tweets, posts, pictures, metadata associated with pictures or other types of ‘posts,’ and any other form of data which is collected from a consumer when accessing the Internet or intranet networks.

Still referring to FIG. 2, at 42 identification analyzer 22 identifies at least one potential product for the consumer. This identification is done utilizing the purchasing information gathered by information gathering system 20. For instance, purchasing information is not limited to the consumer's previous purchases, but can include any data about potential products that the consumer is likely to purchase, consume, or acquire. To this extent, purchasing information should be understood to include recent life events, including but not limited to: becoming pregnant or having a baby; moving to a new location; graduating from high school, college, technical school, graduate school, or the like; changing jobs; changing relationship status, such as getting married, divorced, dating, or becoming single; and upcoming travel plans. Purchasing information may also include a family model that has been built and that may be continually updated with data on the consumer, and optionally other family members, including but not limited to nuclear and extended family, as well as roommates and the like. The family model can include the consumer's (and others') age, gender, interests, geographical location, and similar details.

For purposes of describing embodiments, two examples will be used throughout, but it should be understood that these examples are not meant to be limiting. In the first example (Example 1), a consumer has been determined through the above disclosed gathered purchasing information to be an adult male who is having their first child. As should be understood from the above, this may have been determined by the consumer's searching of baby topics, signing up for email lists to websites that offer services or information related to the birth process, visiting maternity hospital websites, and other known activities. In the second example (Example 2), it has been determined that the consumer is a middle aged male about to embark upon an exotic vacation. In this example, a male has been researching different countries on encyclopedia websites, browsing flight packages to multiple locations, and comparing prices of hotels in numerous locations. Eventually, a ticket was purchased to a specific exotic location.

In any event, identification analyzer 22 is capable of analyzing the purchasing information of information gathering system 20. Using the purchasing information, identification analyzer 22 is capable of determining a consumer's likely needs, current or upcoming, based on their location. In some embodiments, identification analyzer 22 can determine that a consumer will be travelling soon. Based on all gathered information, identification analyzer 22 can identify the at least one potential product based on the consumer's location, travel plans, upcoming weather for current or future location, and any other detail of the gathered purchasing information. The at least one potential product may be an item that will be required in a short period of time, for instance within the next year, or more particularly within the next 6 months. In some embodiments, the potential product may be an item that could be purchased within the next month.

For instance, in Example 1, the potential product is a baby car seat, as the consumer has been researching baby products and has purchased similar items, such as a crib and baby clothing. In Example 2, the potential product is a designer wind jacket. In Example 2, it has been determined by the consumer's purchase of a ticket to an exotic location that the area is likely to experience high winds and rain during the planned vacation using information gleaned from weather websites.

Returning to FIG. 2, at 44, product analyzer 24 may determine whether the at least one potential product is a utility item or a vanity item. As used herein, a utility item refers to any product or service that a consumer likely will need or be required to obtain. In contrast, a vanity item refers to any item or service that the consumer is unlikely to require, but that is likely to be purchased based on a desire of the consumer. In some embodiments, this determination can be simple, as some products simply aren't necessary and are inherently vanity products, whilst some products are required by nearly everyone, or at least nearly every consumer similar to the consumer used for the determination based on the collected purchasing information.

In some embodiments, this determination may be made utilizing aspects of the invention which will be further described below, such as RFID system 32. For example, product analyzer 24 may determine if the consumer owns a plurality of the potential product. If the consumer owns more than a threshold of a certain potential product, the potential product will be considered a vanity item, however if the consumer owns only one or less than a particular threshold, the potential product may be considered a utility item. Similarly, the potential product may be categorized into a category of product. In such embodiments, owning above or below a threshold of items within the category of product may determine whether to categorize the potential product as a vanity item or a utility item. In a further embodiment, if the potential product has been categorized, data from multiple consumers may be used to determine if the potential product is a vanity item. For instance, if multiple users tend to own multiple items of the category, it is likely a vanity item, e.g., sunglasses, women's purses, shoes, and other such items.

Turning to the Examples, in Example 1, the baby car seat has been determined to be a utility item, as a car seat is a necessity for a new baby, and the gathered information indicates that the consumer owns a car. In an example of the RFID embodiments described above, the car seat may have been categorized as a utility item due to the consumer owning no items of the same category, such as the category of “baby carriers.” In Example 2, the designer wind jacket is determined to be a vanity item, as it is designer branded, and the use of a jacket and an umbrella would achieve a similar goal. If using RFID, it may have been determined that the consumer already owns a number of clothing items related to extreme weather, and thus this particular wind jacket is considered vanity due to the consumer owning a number of similar items.

Following 44, turning to FIG. 1, prioritizing engine 26 will utilize one of vanity scoring engine 28 or utility scoring engine 30 based upon the determination of what type of item the potential product is. The methods are similar for both engines, and may share hardware, however as illustrated in FIG. 1, they are illustrated as different components, and will be described separately below. It should be understood that these steps may be carried out in different embodiments as separate components or as a single component.

Returning to FIG. 2, at 46, in response to determining that the at least one potential product is a vanity item, vanity scoring engine 28 (FIG. 1) may determine whether the consumer already owns the vanity item. In some embodiments, vanity scoring engine 28 may determine instead whether the consumer already owns an item in the same category of items, as described above. This is helpful with vanity items as the potential product may be a designer winter jacket, so determining ownership may consist of determining if the consumer owns any jacket of a winter jacket category, rather than a particular jacket. Determining ownership of a vanity item may be accomplished any number of ways. For instance, this information may be gleaned from purchasing information that has been gathered from profile DB 34 by information gathering system 20. However, in some embodiments, as mentioned above, vanity scoring information may have access to RFID system 32 (FIG. 1). RFID system can include one or more RFID readers. As understood in the art, RFID readers are capable of detecting and determining information transmitted wirelessly through electromagnetic fields. This information can be used in identifying and tracking items owned or used by a consumer. RFID readers may be installed in portions of a consumer home, such as closets, bathrooms, bedrooms, kitchens, and pantries to name a few. RFID readers may also be installed in a consumer car, for instance in the dashboard, glovebox, or trunk of the car. It should be understood that in this context, the term car refers to any type of vehicle that the consumer may use for transportation. In some embodiments, a consumer phone, tablet, computer, or other electronic device may include an RFID reader capable of determining what objects the consumer has with them or are currently using.

RFID tags may be active or passive, wherein they may require batteries and constantly send a signal, or they may only passively send a signal when an RFID reader is in the near vicinity. These tags may be utilized in any or all consumer goods, including clothing, children's car seats, appliances, or any product purchased by the consumer. In either case, RFID system 32 is capable of tracking, indexing, and storing any and all items owned, leased, borrowed, or used by the consumer. If products are categorized into types of products, as well as other vanity products and utility products, RFID system 32 can include a storage system that tracks and analyzes RFID information from the RFID reader or plurality thereof. One advantage to using RFID system 32 is that if an item is given to the consumer by any means other than purchasing it, it may still register as ‘owned’ by the consumer, whether handed down, gifted, loaned, or borrowed. In any event, this can affect any determination of ownership of an item and avoid unnecessary advertising of products.

At 48, in response to determining that the consumer does not own the vanity item, vanity scoring engine 28 (FIG. 1) may assign a first advertising score to the vanity item. Multiple advertising scores will be discussed below. The advertising scores described throughout indicate a score based on the process disclosed herein, wherein a high score is indicative of a likely purchase by the consumer of the vanity item or utility item. In contrast, a neutral or low score indicates that the consumer may not purchase the item or is unlikely to purchase the item, respectively. Thus, the advertising scores are intended to predict a conversion rate of an advertisement for the item, or a likelihood of the consumer purchasing the item if presented with an advertisement for the vanity item or the utility item.

Returning to 48 of FIG. 2, based upon the fact that the consumer does not own the vanity item, the first advertising score may be a higher score than neutral, being a vanity item that has been indicated as likely to be purchased by the consumer, and not yet owned. However, it is a vanity item and is set at an initial level slightly higher than neutral, as no other factors have yet been considered. For instance, in response to determining that the consumer owns the vanity item, vanity scoring engine 28 (FIG. 1) may determine whether the vanity item is consumable at 50 of FIG. 2. In response to determining that the consumer cannot consume the vanity item, a second advertising score is assigned at 52. This second advertising score is higher than the first advertising score. However, in response to determining that the vanity item is consumable, vanity scoring engine 28 (FIG. 1) may determine a vanity score for the consumer at 54. Vanity score may be acquired from vanity DB 36 (FIG. 1).

Referring back to FIG. 1, vanity DB 36 may be external to targeted marketing system 18, and directly or indirectly may be in communication with one or both of profile DB 34 and RFID system 32. As illustrated, vanity DB 36 communicates with targeted marketing system 18, which shares information with both profile DB 34 and RFID system 32, thus being indirectly in communication with both. In any event, vanity DB 36 stores a vanity score for the consumer. The vanity score may have been calculated by an external source, for instance by determining the number of items owned by the consumer, the number of vanity items owned by the consumer, the number of items in vanity categories owned by the consumer, the number of the same items or same item categories that the consumer owns, or any other method utilizing some or all of the purchasing information gathered by information gathering system 20, including purchasing histories from multiple websites or email clients, information gathered from RFID system 32, and/or any information contained in profile DB 34.

Generally, when a consumer owns more vanity items or more than one of certain items or categories of items, the vanity score will be higher. The vanity score can be computed as compared to the general population of a respective country, county, town, or city of the consumer. However, in some embodiments, the vanity score may be computed as compared to the consumer's social circle, friends, family, social network groups, or demographics. It is to be understood that the vanity score may include a set of vanity scores for different purposes, such as one for each of the described scenarios, or an average of the plurality of vanity scores. For instance, in Example 2 the consumer is considered “vain.” In this instance, it has been determined that the consumer owns multiple umbrellas of varying prices, a plurality of designer brand jackets, and multiple jackets for a plurality of types of inclement weather. Even within his social circle, the consumer owns more than the average middle-aged man.

Referring back to FIG. 2, the vanity score acquired may be compared to a particular threshold at 54, which can be determined for the particular vanity item, or a general overall threshold may be determined. In any event, in response to determining that the vanity score exceeds the threshold, the consumer may considered to be vain, and vanity scoring engine 28 assigns a third advertising score to the vanity item at 56. The third advertising score is even higher than the second advertising score, as a vain consumer is considered more likely to acquire additional vanity items, despite already owning the same or similar items. At 58, in response to determining that the vanity score falls below a threshold, the consumer is thus not considered vain and a fourth advertising score is assigned to the vanity product. The fourth advertising score may be lower than the first advertising score. That is, since the consumer is not considered vain and already owns the same or a similar vanity item to the one identified, the consumer is considered unlikely to purchase the vanity item, and the fourth advertising score is lower than the first advertising score, and in some embodiments, may be a neutral or negative advertising score.

In a similar method, in response to determining that the at least one potential product is a utility item, utility scoring engine 30 (FIG. 1) can determine whether the consumer owns the utility item at 60. At 62, in response to determining that the consumer does not own the utility item, a fifth advertising score is assigned. The fifth advertising score may be equal to the first advertising score, however in some embodiments, the fifth advertising score may be higher than the first advertising score. For example, a utility item may be considered to be more likely to be purchased than a vanity item, considering that the consumer does not own the item. In either event, in response to determining that the consumer does own the utility item, utility scoring engine 30 determines if the utility item is consumable at 64. In response to the utility item not being consumable, a sixth advertising score is assigned to the utility item at 66 which is higher than the first advertising score. However, in response to determining that the utility item is consumable, a seventh advertising score is assigned to the utility item at 68. The seventh advertising score is lower than the sixth advertising score, and in some embodiments the seventh advertising score may be lower than the first advertising score.

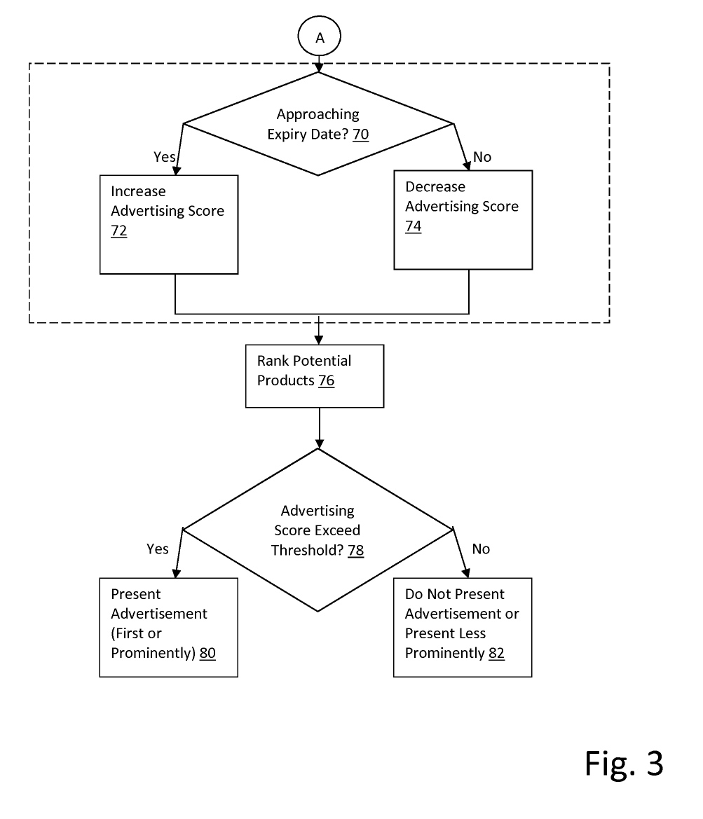

As illustrated in FIG. 3, following any of the advertising scores that occur as the final step of the process at steps 48, 52, 56, 58, 62, 66, or 68 of FIG. 2, in a further embodiment, one or both of vanity scoring engine 28 (FIG. 1) and utility scoring engine 30 (FIG. 1) may determine if the vanity item or the utility item is approaching an expiry date at 70 (FIG. 3). It should be appreciated that many products may have expiry dates, whether explicitly labelled on the product or not. In some embodiments, food and similar items have a printed expiry date. However, other items such as child car seats (Example 1) and baby care items have expiry dates included. Even further, many items do not have a manufacturer issued expiry date but are considered useful over a limited amount of time. Information on non-explicit expiry dates can be obtained from any source including the internet, forums on certain products or product categories, or the consumer's purchase history indicating that an item is repeat purchased after a given amount of time.

In any event, when the expiry date is determined to be approaching, the respective advertising score may be increased at 72 (FIG. 3), and when the expiry date is not approaching or does not exist, the respective advertising score may be decreased at 74 (FIG. 3). The increase or decrease can be of any increment determined by targeted marketing system 18. Illustrated within dotted line, these steps are intended to be optional steps. For instance, each of steps 70, 72, and 74 may be skipped and the method can proceed to the description below.

In a further embodiment, still referring to FIG. 3, upon assigning an advertising score to the vanity item or the utility item at any of the end of processes illustrated in FIG. 2 (steps 48, 52, 56, 58, 62, 66, or 68), potential products may be ranked by their advertising score at 76. In the case that there is only a single vanity item or utility item, this step simply ranks a single item. In some embodiments, as further described below, there may be more than one potential product identified, in which case step 76 will be further described below. In any event, at 78 (FIG. 3) it may be determined if the advertising score assigned exceeds a threshold. In response to the advertising score exceeding an advertising threshold, an advertisement may be presented to the consumer at 80. The advertisement can be of any form now known or later developed, including any form of digital advertising such as an email, an advertisement within a page of a website on the Internet, or any other form of advertisement, printed or otherwise.

Still referring to FIG. 3, in response to the advertising score falling below the advertising threshold for a single utility item or vanity item, an advertisement for the utility item or the vanity item may not be presented at 82. This threshold can be set by any known means, and typically indicates a threshold at which the advertising score is more likely to result in a sale, or a higher conversion rate. In some instances, the threshold may indicate a predicted percentage chance that the advertisement will result in a sale. In these instances, the threshold may include a 75% chance of conversion to a sale, or in some instances an 85% chance of conversion.

In some embodiments, more than one potential product may be identified. As illustrated in FIG. 3, each potential product may be put through the above disclosed steps illustrated in FIG. 2. When processing a plurality of potential products, vanity scoring engine 28 and utility scoring engine 30 may run separately or simultaneously after each potential product is determined to be either a utility item or a vanity item at 44 (FIG. 2). Following the assignment of the advertising score for each potential product at 48, 52, 56, 58, 62, 66, or 68 of FIG. 1, each potential product identified can be ranked at 76 (FIG. 3) based on the resulting advertising scores determined for each vanity item and each utility item. This ranking can include putting each vanity item in order of high to low advertising score and each utility item in order, or in some embodiments all vanity items and utility items may be grouped and ranked by advertising score.

Following ranking, at 78 (FIG. 3) it can further be determined whether the advertising score for each of the plurality of potential products exceeds an advertising threshold, similar to that as described above in reference to a single potential product. In embodiments where an advertisement is presented to the consumer, the highest ranking items may be presented first or more prominently to the consumer at 80. For instance, the advertisement can include a full page advertisement or a specific email about the product. At 82, in response to the advertising score not exceeding a threshold, the lower ranked items may be presented at a later date or not presented at all. They may also be presented in a less prominent fashion, for instance as a small side advertisement, or in an email with a different main product being advertised.

As will be appreciated from the above disclosure, features of the invention allow for more effective prioritizing of advertisements than previously possible. For instance, items can be marketed to the consumer in a narrow time frame, and advertisements for already owned items can be avoided, or encouraged in the case of vanity items to a ‘vain’ consumer. In some embodiments, even items which have been given as a gift, borrowed, or handed down in the family can be detected and not advertised. Further, sales conversion rates can be increased by using the above disclosed systems and methods to prioritize advertising, which can cost time, resources, and particularly money in presenting any advertisements to a consumer. The advantages of classifying and prioritizing advertisements are computer implemented advantages, wherein the problem of poorly targeted advertising arises from the use of computer implemented advertising, especially over the Internet. Embodiments of the current invention overcome the problem of targeted advertising, particularly over the Internet, which results in advertisements for already purchased items after using, for instance, the consumer's browser history and email as a source for advertisements.

As noted above, the targeted marketing system 18 may be implemented as a computer program product stored on a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of various embodiments of the present invention have been presented for purposes of illustration and description, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A targeted marketing system that prioritizes Internet advertising for a particular product for a consumer, comprising:
an information gathering system that gathers purchasing information of a consumer;
an identification analyzer that identifies at least one potential product for the consumer;
a product analyzer that determines whether the at least one potential product is a utility item or a vanity item; and
a prioritizing engine comprising:
a vanity scoring engine that, in response to the at least one potential product being a vanity item, assigns an advertising score based on whether the consumer owns the vanity item, whether the vanity item is consumable, and a vanity score for the consumer; and
a utility scoring engine that, in response to the at least one potential product being a utility item, assigns an advertising score based on whether the consumer owns the utility item and whether the utility item is consumable,
wherein in response to the assigned advertising score exceeding an advertising threshold, an Internet advertisement is presented to the consumer by the prioritizing engine.

2. The targeted marketing system of claim 1, further including:
wherein the vanity scoring engine further:
determines whether the consumer owns the vanity item, and in response to determining that the consumer does not own the vanity item, assigns a first advertising score to the vanity item;
determines, in response to determining that the consumer owns the vanity item, whether the vanity item is consumable, and in response to determining that the vanity item is not consumable, assigns a second advertising score that is higher than the first advertising score;
determines, in response to determining that the vanity item is consumable, a vanity score for the consumer, and in response to determining that the consumer is vain based on the vanity score exceeding a threshold, assigns a third advertising score that is higher than the second advertising score, and in response to determining that the consumer is not vain based on the vanity score falling below the threshold, assigns a fourth advertising score that is lower than the first advertising score; and
wherein the utility scoring engine further: determines whether the consumer owns the utility item, and in response to determining that the consumer does not own the utility item, assigns a fifth advertising score to the utility item that is equal to the first advertising score; and
determines, in response to determining that the consumer owns the utility item, whether the utility item is consumable, and in response to determining that the utility item is not consumable, assigns a sixth advertising score that is higher than the first advertising score, and in response to determining that the utility item is consumable, assigns a seventh advertising score that is lower than the first advertising score.

3. The targeted marketing system of claim 1, wherein the vanity scoring engine and the utility scoring engine further determine if the vanity item or the utility item is approaching an expiry date.

4. The targeted marketing system of claim 3, wherein in response to the expiry date approaching, increasing the respective advertising score, and in response to the expiry date not approaching, decreasing the respective advertising score.

5. The targeted marketing system of claim 1, wherein the determining whether the consumer owns the vanity item or the utility item is achieved using an RFID system.

6. The targeted marketing system of claim 5, wherein the RFID system includes an RFID reader for reading a passive RFID chip.

7. The targeted marketing system of claim 6, wherein the RFID system is installed in at least one of: a portion of a consumer home, a consumer car, and a consumer mobile device.

8. The targeted marketing system of claim 1, wherein the information gathering system gathers information on the consumer from at least one of: the Internet, a browser history, a social network profile, and an email client.

9. A computer program product stored on a computer readable storage medium, which when executed by a computing system, prioritizes Internet advertising for a particular product for a consumer, comprising:
program code that gathers purchasing information of a consumer;
program code that identifies at least one potential product for the consumer;
program code that determines whether the at least one potential product is a utility item or a vanity item; and
program code that prioritizes, by:
in response to determining that the at least one potential product is a vanity item, assigning an advertising score based on whether the consumer owns the vanity item, whether the vanity item is consumable, and a vanity score for the consumer; and
in response to determining that the at least one potential product is a utility item, assigning an advertising score based on whether the consumer owns the utility item whether the utility item is consumable,
wherein in response to the assigned advertising score exceeding an advertising threshold, an Internet advertisement is presented to the consumer by the program code that prioritizes.

10. The program product of claim 9, wherein the program code that prioritizes further performs:
in response to determining that the at least one potential product is a vanity item:
determining whether the consumer owns the vanity item, and in response to determining that the consumer does not own the vanity item, assigning a first advertising score to the vanity item;
determining, in response to determining that the consumer owns the vanity item, whether the vanity item is consumable, and in response to determining that the vanity item is not consumable, assigning a second advertising score that is higher than the first advertising score;
determining, in response to determining that the vanity item is consumable, a vanity score for the consumer, and in response to determining that the consumer is vain based on the vanity score exceeding threshold, assigning a third advertising score that is higher than the second advertising score, and in response to determining that the consumer is not vain based on the vanity score falling below the threshold, assigning a fourth advertising score that is lower than the first advertising score; and
in response to determining that the at least one potential product is a utility item:
determining whether the consumer owns the utility item, and in response to determining that the consumer does not own the utility item, assigning a fifth advertising score to the utility item that is equal to the first advertising score; and
determining, in response to determining that the consumer owns the utility item, whether the utility item is consumable, and in response to determining that the utility item is not consumable, assigning a sixth advertising score that is higher than the first advertising score, and in response to determining that the utility item is consumable, assigning a seventh advertising score that is lower than the first advertising score

11. The program product of claim 9, wherein the program code that prioritizes further performs:
determining whether the vanity item or the utility item is approaching an expiry date.

12. The program product of claim 11, wherein in response to the expiry date approaching, increasing the respective advertising score, and in response to the expiry date not approaching, decreasing the respective advertising score.

13. The program product of claim 9, wherein the determining whether the consumer owns the vanity item or the utility item is achieved using an RFID system.

14. The program product of claim 13, wherein the RFID system includes an RFID reader for reading a passive RFID chip.

15. The program product of claim 14, wherein the RFID system is installed in at least one of: a portion of a consumer home, a consumer car, and a consumer mobile device.

16. The program product of claim 9, wherein the information gathered on the consumer is gathered from at least one of: the Internet, a browser history, a social network profile, and an email client.

17. A method for prioritizing Internet advertising for a particular product for a consumer, comprising:
gathering purchasing information of a consumer;
identifying at least one potential product for the consumer;
determining whether the at least one potential product is a utility item or a vanity item; and
prioritizing, by:
in response to determining that the at least one potential product is a vanity item, assigning an advertising score based on whether the consumer owns the vanity item, whether the vanity item is consumable, and a vanity score for the consumer; and
in response to determining that the at least one potential product is a utility item, assigning an advertising score based on whether the consumer owns the utility item and whether the utility item is consumable,
wherein in response to the assigned advertising score exceeding an advertising threshold, an Internet advertisement is presented to the consumer.

18. The method of claim 17, further including:
in response to determining that the at least one potential product is a vanity item:
determining whether the consumer owns the vanity item, and in response to determining that the consumer does not own the vanity item, assigning a first advertising score to the vanity item;
determining, in response to determining that the consumer owns the vanity item, whether the vanity item is consumable, and in response to determining that the vanity item is not consumable, assigning a second advertising score that is higher than the first advertising score;
determining, in response to determining that the vanity item is consumable, a vanity score for the consumer, and in response to determining that the consumer is vain based on the vanity score exceeding a threshold, assigning a third advertising score that is higher than the second advertising score, and in response to determining that the consumer is not vain based on the vanity score falling below the threshold, assigning a fourth advertising score that is lower than the first advertising score; and
in response to determining that the at least one potential product is a utility item:
determining whether the consumer owns the utility item, and in response to determining that the consumer does not own the utility item, assigning a fifth advertising score to the utility item that is equal to the first advertising score;
determining, in response to determining that the consumer owns the utility item, whether the utility item is consumable, and in response to determining that the utility item is not consumable, assigning a sixth advertising score that is higher than the first advertising score, and in response to determining that the utility item is consumable, assigning a seventh advertising score that is lower than the first advertising score.

19. The method of claim 17, further including:
determining whether the vanity item or the utility item is approaching an expiry date.

20. The method of claim 19, wherein in response to the expiry date approaching, increasing the respective advertising score, and in response to the expiry date not approaching, decreasing the respective advertising score.
